(19) United States
(12) Patent Application Publication
(10) Pub. No.: US 2024/0091974 A1
(43) Pub. Date: Mar. 21, 2024

(54) APPARATUS FOR CONDITIONING AN EDGE OF A SUBSTRATE USING A WATER JET

(71) Applicant: Toyota Motor Engineering & Manufcturing North America, Inc., Plano, TX (US)

(72) Inventors: Lindsay A. Babian, Canton, MI (US); Nazul M. Rivera, San Antonia, TX (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 17/948,396

(22) Filed: Sep. 20, 2022

(51) Int. Cl. B26F 3/00; B05B 1/26

(52) U.S. Cl. CPC B26F 3/004; B05B 1/262; B26F 2003/006

(57) ABSTRACT

Apparatuses described herein relate to coniditioning an edge of a substrate using a water jet. In one embodiment, an apparatus includes a nozzle connected on a receiving end with a connecting tube to receive a water jet that is a stream of water accelerated at a high velocity to generate a high pressure for cutting a substrate, where the water jet exits through the nozzle. The appartus further includes a deflector coupled to the nozzle, where the deflector splits the water jet into a cutting stream of water for cutting the substrate and an angled stream of water for conditioning an edge of the substrate.

### TECHNICAL FIELD

The subject matter described herein relates, in general, to conditioning an edge of a substrate that has been cut using a water jet, and, more particularly, to using a deflector to split a water jet stream into a cutting stream and an angled stream of water to cut and to condition the substrate.

### BACKGROUND

Cutting a substrate, such as a vehicle headliner, with a water jet results in the formation of a sharp, rigid edge along the sides of the substrate. A cut-out headliner may need to be mated with other components, such as a seat belt bezel. To mate other components to the headliner and to install the headliner in a vehicle, the sharp edge needs to be conditioned (e.g., crushed or deformed) which requires a high force. If the edge is not conditioned, the headliner can become damaged when it is installed into a vehicle and mated with other parts due to the force required to crush the sharp edge so that the headliner fits in the vehicle and/or can mate with other parts. This may result in the installed headliner containing creases or dents.

### SUMMARY

Example apparatuses disclosed herein relate to a manner of conditioning an edge of a substrate that has been cut using a water jet. As previously noted, when a water jet is used to cut a substrate, the resultant cutout has a sharp edge that may make the substrate difficult to install/mate with other components. As a result, substrates with a sharp edge can leave a finished product, such as a headliner installed in a vehicle, looking deformed. For example, in the context of a headliner, a production worker may need to mate other components, such as a seat belt bezzle to a cutout headliner. Because the cutout headliner has a sharp edge, the production worker is required to crush the edge using force to allow the seat belt bezel to mate with the headliner cutout. This can result in the installed headliner looking creased or dented.

Therefore, in one embodiment, an apparatus that improves the process of conditioning an edge of a cutout substrate is disclosed. The apparatus includes, in one arrangement, a nozzle connected on a receiving end with a connecting tube to receive a water jet. The water jet is a stream of water accelerated at a high velocity to generate a high pressure for cutting a substrate. The water jet exits through the nozzle to contact the substrate. The apparatus further includes, in one configuration, a deflector coupled to the nozzle. The deflector splits the water jet into a cutting stream of water for cutting the substrate and an angled stream of water for conditioning an edge of the substrate. For example, when the water jet exits the nozzle a portion of the water jet contacts the deflector, causing the portion of the water jet that contacts the deflector to become the angled stream and the portion of the water jet that does not contact the deflector to become the cutting stream. The deflector is, in one or more aspects, a member that is capable of coupling to the nozzle and strong enough to withstand the force of the water jet as the water jet contacts the deflector without deforming or breaking off of the nozzle. For example, the deflector is, in one approach, a steel member.

In one approach, the cutting stream contacts the substrate at an angle that is substantially perpendicular to a top surface of the substrate to cut the substrate. The top surface of the substrate is the area of the substrate located outside of and substantially perpendicular to the nozzle. Once the substrate is cut, a substrate cutout is formed, where the substrate cutout includes a core located between the top surface of the substrate and a bottom surface of the substrate, the top surface opposing the bottom surface, and where the substrate includes an edge located at a corner of the top surface of the substrate. In one embodiment, the angled stream contacts the edge of the substrate at a non-perpendicular angle in relation to the top surface of the substrate to form a conditioned edge. In one arrangement, the angled stream forms the conditioned edge by removing a portion of the edge, dulling the edge, smoothing the edge, etc. In any case, the conditioned edge has a reduced stiffness in comparison to the edge that was originally formed when the substrate was cut.

The deflector may be coupled to the nozzle in various manners. In one configuration, the deflector is integrated into the nozzle. For example, the deflector may be an extension of the nozzle, where the surface of the deflector extends beneath a portion of the nozzle. Accordingly, when the water jet exits the nozzle, the deflector splits the water jet into the cutting stream and the angled stream. In one approach, the deflector is removably coupled to the exterior of the nozzle. For example, a portion of the deflector may be screwed into the side of the nozzle, while another portion of the deflector extends beneath a portion of the nozzle. When the water jet exits the nozzle, the deflector splits the water jet into the cutting stream and the angled stream. Additionally, since the deflector is removably coupled to the nozzle, a user may remove the deflector when the user does not wish to condition an edge of a substrate. In one embodiment, the deflector includes a divider located within an interior portion of the nozzle and a plate located outside of the nozzle, where the plate is removably coupled to the exterior of the nozzle. As such, the divider splits the water jet into the cutting stream and the angled stream before or as the water jet exits the nozzle. After the water jet is split by the divider, the plate contacts the angled stream to cause the angled stream to contact the top surface of the substrate at a non-perpendicular angle. In any case, the deflector is coupled to the nozzle in a manner that allows the deflector to intersect and split the water jet into a cutting stream and angled stream of water for cutting and conditioning a substrate.

In one approach, the deflector includes a movable contact, the movable contact being the portion of the deflector that splits the water jet into a cutting stream and angled stream, a non-movable anchor where the non-movable anchor is attached to the nozzle, and a hinge, where the movable contact and the non-movable anchor are connected by the hinge. The movable contact is rotatable along the hinge.

In one configuration, the apparatus further includes a sliding rail attached to an exterior of the nozzle, where the deflector is coupled to the sliding rail, and where the deflector is movable between an active position and an inactive position along the sliding rail. The apparatus includes one or more pins coupled to the sliding rail, where the one or more pins lock the deflector in the active position and the inactive position on the sliding rail when the one or more pins are engaged. The active position is any position along the sliding rail that allows the deflector to come into contact with the water jet. The inactive position is any position along the sliding rail that prevents the deflector from contacting the water jet. In any case, by coupling the deflector to a sliding rail with one or more pins, a user can selectively allow the deflector to intersect the water jet by moving the deflector along the sliding rail. In this way, the apparatus improves the process of cutting and conditioning the edge of a substrate using a water jet.

In one embodiment, an apparatus is disclosed. The apparatus includes a nozzle connected on a receiving end with a connecting tube to receive a water jet that is a stream of water accelerated at a high velocity to generate a high pressure for cutting a substrate, where the water jet exits through the nozzle. The appartus further includes a deflector coupled to the nozzle, where the deflector splits the water jet into a cutting stream of water for cutting the substrate and an angled stream of water for conditioning an edge of the substrate.

In one embodiment, an apparatus is disclosed. The apparatus includes a nozzle connected on a receiving end with a connecting tube to receive a water jet that is a stream of water accelerated at a high velocity to generate a high pressure for cutting a substrate, where the water jet exits through the nozzle. The appartus further includes a deflector coupled to the nozzle, where the deflector splits the water jet into a cutting stream of water for cutting the substrate and an angled stream of water for conditioning an edge of the substrate. The cutting stream of water contacts the substrate at an angle that is substantially perpendicular to a top surface of the substrate to cut the substrate, where the top surface of the substrate is an area of the substrate located outside of and substantially perpendicular to an opening of the nozzle. The angled stream of water contacts the edge of the substrate at a non-perpendicular angle in relation to the top surface of the substrate to form a conditioned edge having an angle that is non-perpendicular in relation to the top surface of the substrate. The apparatus further includes a sliding rail attached to an exterior of the nozzle, where the deflector is coupled to the sliding rail, and where the sliding rail provides for moving the deflector between an active position and an inactive position.

In one embodiment, an apparatus is disclosed. The apparatus includes a nozzle connected on a receiving end with a connecting tube to receive a water jet that is a stream of water accelerated at a high velocity to generate a high pressure for cutting a substrate, where the water jet exits through the nozzle. The appartus further includes a deflector coupled to the nozzle, where the deflector splits the water jet into a cutting stream of water for cutting the substrate and an angled stream of water for conditioning an edge of the substrate. The cutting stream of water contacts the substrate at an angle that is substantially perpendicular to a top surface of the substrate to cut the substrate, where the top surface of the substrate is an area of the substrate located outside of and substantially perpendicular to an opening of the nozzle. The angled stream of water contacts the edge of the substrate at a non-perpendicular angle in relation to the top surface of the substrate to form a conditioned edge having an angle that is non-perpendicular in relation to the top surface of the substrate. The deflector is removably coupled to an exterior portion of the nozzle. The deflector includes a movable contact, a non-movable anchor, where the non-movable anchor is attached to the nozzle, and a hinge, where the movable contact and the non-movable anchor are connected by the hinge, where the movable contact is rotatable along the hinge, and where rotating the movable contact changes an angle of the angled stream. The apparatus further includes a sliding rail attached to an exterior of the nozzle, where the deflector is coupled to the sliding rail, and where the sliding rail provides for moving the deflector between an active position and an inactive position.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of an apparatus that includes a deflector attached to an exterior of a nozzle to split a water jet stream into a cutting stream and an angled stream of water.

FIG. 2 illustrates one embodiment of an apparatus that includes a deflector integrated with a nozzle to split a water jet stream into a cutting stream and an angled stream of water.

FIG. 3 illustrates a zoomed-in view of the appartus of FIG. 2.

FIG. 4 illustrates one embodiment of an apparatus that includes a deflector comprising a divider and a plate.

FIG. 5 illustrates a three-dimensional (3D) view of the apparatus of FIG. 4.

FIG. 6 illustrates one embodiment of an adjustable deflector.

FIG. 7 illustrates one embodiment of a deflector that splits a water jet stream into a cutting stream and an angled stream of water, where the deflector is in an active position.

FIG. 8 illustrates one embodiment of a deflector that splits a water jet stream into a cutting stream and an angled stream of water, where the deflector is in an inactive position.

FIG. 9 illustrates one embodiment of a substrate that has been cut by a cutting stream of water.

FIG. 10 illustrates one embodiment of a substrate comprising a conditioned edge.

### DETAILED DESCRIPTION

Example apparatuses associated with improving the process of cutting and conditioning the edge of a substrate using a water jet are disclosed herein. Currently, when a water jet is used to cut a substrate, the resultant cutout has a sharp edge that may make the substrate difficult to install/mate with other components. In the context of a headliner, a production worker may need to mate other components, such as a seat belt bezel to a cutout headliner. To successfully mate the seat belt bezel to the headliner, the production worker uses force to crush the edge of the substrate so that the bezel can reach its final position. Using force to condition the edge of the headliner cutout may deform the cutout and leave the installed headliner looking wrinkled or dented.

Therefore, in one embodiment, an apparatus that improves the process of conditioning an edge of a cutout substrate is disclosed. The apparatus includes, in one arrangement, a nozzle connected on a receiving end with a connecting tube to receive a water jet. The water jet is a stream of water accelerated at a high velocity to generate a high pressure for cutting a substrate. The pressure necessary for cutting the substrate may range, for example, between 30,000 and 90,000 pounds per square inch (psi). The water jet exits through the nozzle to contact the substrate. The apparatus further includes, in one configuration, a deflector coupled to the nozzle. The deflector splits the water jet into a cutting stream of water for cutting the substrate and an angled stream of water for conditioning an edge of the substrate when the water jet contacts the deflector. For example, when the water jet exits the nozzle a portion of the water jet contacts the deflector, causing the portion of the water jet that contacts the deflector to become the angled stream. By contacting the deflector, the angled stream of water may have a reduced pressure in comparison to the water jet, which allows the angled stream to condition the edge. The portion of the water jet that does not contact the deflector becomes the cutting stream. The cutting stream exits the nozzle at the same velocity and pressure of the water jet to cut the substrate. The deflector is, in one or more aspects, an apparatus that is capable of coupling to the nozzle and strong enough to withstand the force of the water jet as the water jet contacts the deflector without deforming or breaking. For example, the deflector is, in one approach, a steel member.

In one approach, the cutting stream contacts the substrate at an angle that is substantially perpendicular to a top surface of the substrate to cut the substrate. The top surface of the substrate is the area of the substrate located outside of and substantially perpendicular to the nozzle. Once the substrate is cut, an edge is formed. In one embodiment, the angled stream contacts the edge of the substrate at a non-perpendicular angle in relation to the top surface of the substrate to form a conditioned edge, where the substrate is substantially planar and includes a core between the top surface and a bottom surface, with the top surface opposing the bottom surface, and where the edge is located at an end of the top surface. In one arrangement, the angled stream forms the conditioned edge by removing a portion of the edge, dulling the edge, smoothing the edge, etc. As such, in one approach, the substrate with the conditioned edge may be installed/mated with other components without requiring a user to manually condition the edge using force.

The deflector may be coupled to the nozzle in various manners. In one configuration, the deflector is integrated into the nozzle. For example, the deflector may be an extension of the nozzle, where the surface of the deflector extends beneath a portion of the nozzle. Accordingly, when the water jet exits the nozzle, the deflector splits the water jet into the cutting stream and the angled stream. In one approach, the deflector is removably coupled to the exterior of the nozzle. For example, a portion of the deflector may be screwed into the side of the nozzle, while another portion of the deflector extends beneath a portion of the nozzle. When the water jet exits the nozzle, the deflector splits the water jet into the cutting stream and the angled stream. Additionally, since the deflector is removably coupled to the nozzle, a user may remove the deflector when the user does not wish to condition an edge of a substrate. For example, the user may remove the deflector by unscrewing the deflector from the nozzle. In one embodiment, when the deflector is removed, the water jet is not split into the cutting stream and angled stream, and the water jet cuts the substrate without conditioning an edge of the substrate.

In one embodiment, the deflector includes a divider located within an interior portion of the nozzle and a plate located outside of the nozzle, where the plate is removably coupled to the exterior of the nozzle. The plate may be screwed to an exterior portion of the nozzle, for example. In one configuration, the divider splits the water jet into the cutting stream and the angled stream before or as the water jet exits the nozzle. After the water jet is split by the divider, both the cutting stream and the angled stream exit the nozzle as separate streams of water. In one approach, the plate contacts the angled stream to cause the angled stream to contact the top surface of the substrate at a non-perpendicular angle, forming a conditioned edge. In any case, the deflector is coupled to the nozzle in a manner that allows the deflector to intersect and split the water jet into a cutting stream and angled stream of water for cutting and conditioning a substrate.

The position of the surface of the deflector that contacts the water jet in relation to the nozzle may be adjustable. In one approach, the deflector includes a movable contact, the movable contact being the portion of the deflector that splits the water jet into a cutting stream and angled stream, a non-movable anchor where the non-movable anchor is attached to the nozzle, and a hinge, where the movable contact and the non-movable anchor are connected by the hinge. The movable contact is rotatable along the hinge. Rotating the movable contact allows a user to adjust the angle at which the angled stream contacts the substrate. Accordingly, rotating the movable contact allows for a user to customize the manner in which an edge is conditioned.

In one configuration, the apparatus further includes a sliding rail attached to an exterior of the nozzle, where the deflector is coupled to the sliding rail, and where the deflector is movable between an active position and an inactive position along the sliding rail. The apparatus includes one or more pins coupled to the sliding rail, where the one or more pins lock the deflector in the active position and the inactive position on the sliding rail when the one or more pins are engaged. For example, in one arrangement, the sliding rail includes two pins. When the sliding rail is in the active position, the first pin is engaged, the second pin is disengaged, and the deflector is locked in the active position due to the engagement of the first pin. The active position is any position along the sliding rail that allows the deflector to contact the water jet. On the other hand, when the second pin is engaged, and the first pin is disengaged, the water jet is locked in the inactive position. The inactive position is any position along the sliding rail that prevents the deflector from contacting the water jet. Accordingly, the deflector does not contact the water jet, and the water jet is not split into the cutting and angled streams when the second pin is engaged. In any case, by coupling the deflector to a sliding rail with one or more pins, a user can selectively allow the deflector to intersect the water jet by moving the deflector along the sliding rail. In this way, the apparatus improves the process of cutting and conditioning the edge of a substrate using a water jet.

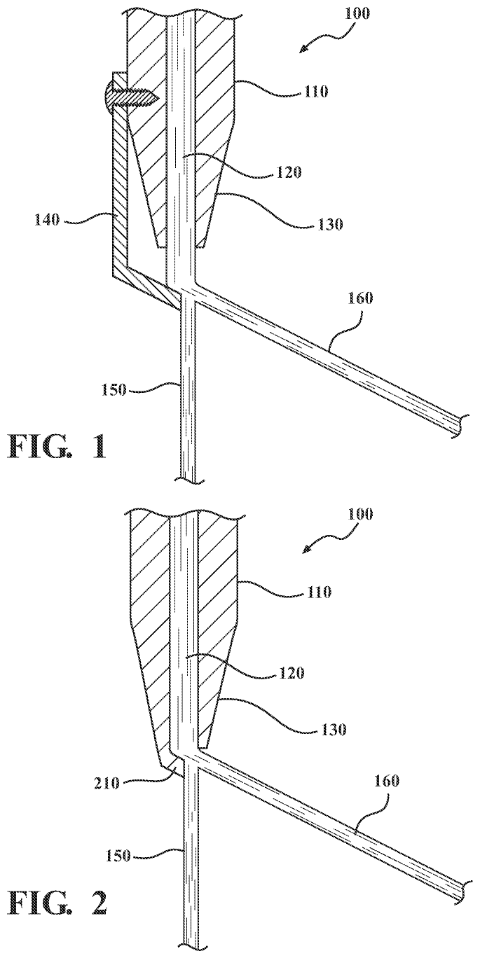

Referring to FIG. 1, an example of an apparatus 100 is illustrated. As used herein, the apparatus 100 is associated with cutting and conditioning an edge of a substrate using a water jet. The apparatus 100 includes various elements. It will be understood that in various embodiments it may not be necessary for the apparatus 100 to have all of the elements shown in FIG. 1. The apparatus 100 can have any combination of the various elements shown in FIG. 1. Further, the apparatus 100 can have additional elements to those shown in FIG. 1. In some arrangements, the apparatus 100 may be implemented without one or more of the elements shown in FIG. 1.

Some of the possible elements of the apparatus 100 are shown in FIG. 1 and will be described along with subsequent figures. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

In one configuration, the apparatus 100 includes a nozzle 130 connected on a receiving end with a connecting tube 110 to receive a water jet 120. In one embodiment, the nozzle 130 and the connecting tube 110 are integrated into a machine for receiving and releasing the water jet 120. For example, the machine may be a water jet cutter that includes the connecting tube 110 and the nozzle 130 located on an end of the water jet cutter. In one approach, the water jet 120 is received by the connecting tube 110 and exits the machine via an opening of the nozzle 130. The nozzle 130 is, in one configuration, an attachment of the machine, where the nozzle 130 is removably coupled to the machine. In one arrangement, water used to form the water jet 120 is received from any source of water, such as a tank. In one approach, a pump, such as a hydraulic intensifier pump or a crankshaft pump, pressurizes a stream of water to form the water jet 120 by accelerating the stream of water at a high velocity to generate a high pressure for cutting a substrate. For example, the pump may pressurize the water to a pressure between 30,000 and 90,000 pounds per square inch (psi). In one embodiment, the connecting tube 110 is connected to the pump to receive the water jet 120. As such, in one configuration, the water jet 120 travels from the pump to the connecting tube 110, travels through the connecting tube 110, and exits through the nozzle 130.

In one approach, the apparatus 100 includes a deflector 140 coupled to the nozzle 130. In one embodiment, the deflector 140 has a surface that extends beneath a portion of the nozzle 130. The deflector 140, in one arrangement, does not extend beneath the entire opening of the nozzle 130. In this way, the deflector 140 only intersects a portion of the water jet 120. Accordingly, when the water jet 120 exits the nozzle 130, the water jet 120 contacts the deflector 140, and the deflector 140 splits the water jet 120 into a cutting stream of water 150 for cutting the substrate and an angled stream of water 160 for conditioning an edge of the substrate. In one approach, the cutting stream 150 and angled stream 160 become separate streams that do not intersect one another when the water jet 120 contacts the deflector. In one embodiment, the deflector 140 is made of any material that is capable of withstanding the force of the water jet 120 as the water jet 120 contacts the deflector 140. For example, the deflector 140 may be formed from a metal material, such as steel, formed from nylon, or formed from any other material that allows the deflector 140 to withstand the force of the water jet 120 without breaking off of the nozzle 130 or becoming deformed.

The deflector 140, in one embodiment, does not contact the portion of the water jet 120 that becomes the cutting stream 150. In this way, the cutting stream 150 has substantially the same velocity and pressure of the water jet 120 which allows the cutting stream 150 to cut the substrate. On the other hand, in one approach, the angled stream of water 160, by contacting the deflector 140, may have a reduced pressure in comparison to the water jet 120. For example, the pressure of the angled stream 160 is a pressure that allows the angled stream 160 to condition the edge of the substrate without cutting the substrate. A substrate, as used herein, is any material that may be cut with the water jet 120. For example, the substrate may be a soft material, such as fabric, or a hard material, such as metal. In one embodiment, the substrate is a polyurethane foam composition vehicle headliner.

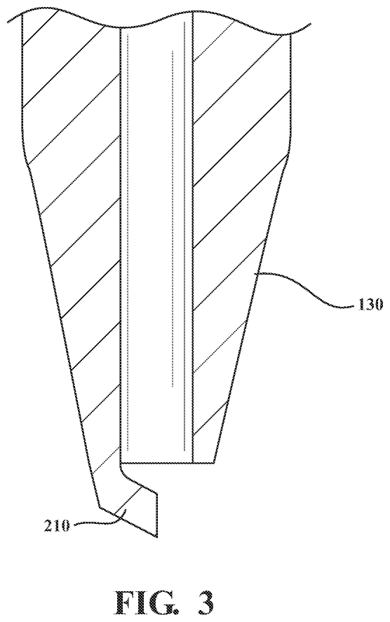

The deflector 140 may be coupled to the nozzle 130 in various manners. In one configuration, as shown in FIG. 1, the deflector 140 is removably coupled to an exterior portion of the nozzle 130. For example, the deflector 140, in one approach, is coupled to the exterior portion of the nozzle 130 using a screw to hold the deflector 140 in place. To remove the deflector 140, a user can unscrew the screw and decouple the deflector 140 from the nozzle 130. The discussion will now shift to FIGS. 2-3 to describe an alternate embodiment for coupling the deflector to the nozzle 130.

With reference to FIGS. 2 and 3, deflector 210, in one or more arrangements, is integrated into the nozzle 130. FIG. 2 illustrates one embodiment of the apparatus 100 that uses the deflector 210 integrated with the nozzle 130 to split the water jet 120 into the cutting stream 150 and the angled stream 160. In one arrangement, the apparatus 100 includes the connecting tube 110 for receiving the water jet 120. FIG. 3 illustrates a zoomed-in view of the nozzle 130 and the deflector 210 of FIG. 2. As shown in FIG. 3, the deflector 210 is, in one approach, an extension of the nozzle 130. In one embodiment, the deflector 210 extends beneath a portion of the opening of the nozzle 130 to intersect a portion of the water jet 120. Discussion will now transition back to FIG. 1 to explain how the cutting stream 150 and angled stream 160 cut and condition an edge of a substrate.

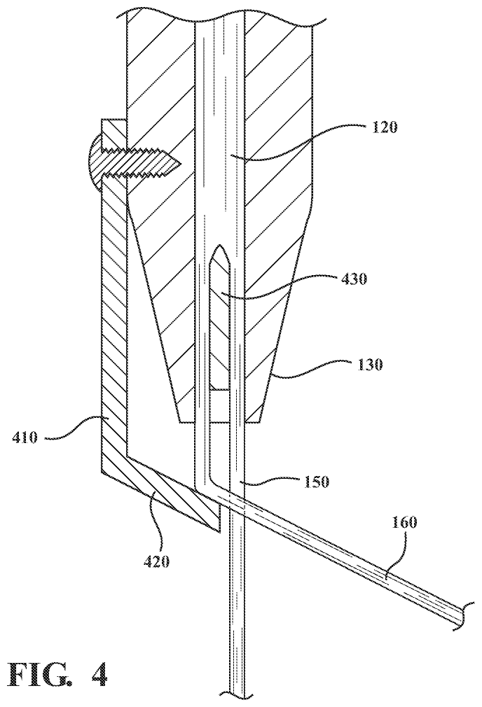

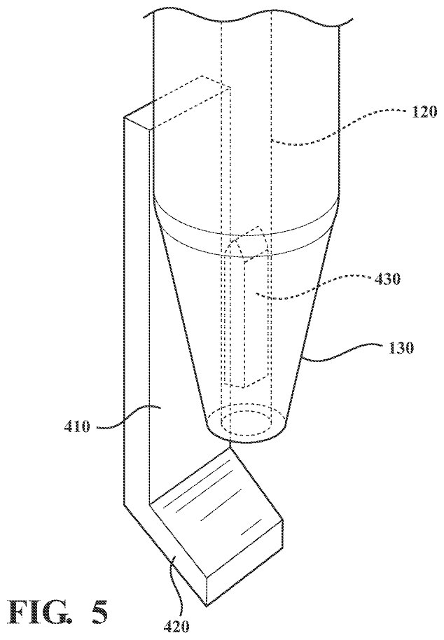

With continued reference to FIG. 1, in one or more arrangements, the cutting stream of water 150 contacts the substrate at an angle that is substantially perpendicular to a top surface of the substrate to cut the substrate. The top surface of the substrate is an area of the substrate located outside of and substantially perpendicular to an opening of the nozzle 130. In one approach, when the cutting stream 150 contacts the substrate, the cutting stream 150 splits the substrate, forming an edge on an end of the top surface of the substrate. In one embodiment, the angled stream of water 160 contacts the edge of the substrate at a non-perpendicular angle in relation to the top surface of the substrate to form a conditioned edge, the substrate being substantially planar, including a core between the top surface and a bottom surface, with the top surface opposing the bottom surface, and where the edge is located at an end of the top surface. The angled stream 160 may form the conditioned edge by, for example, removing a portion of the edge, dulling the edge, smoothing the edge, etc. The discussion will now shift to FIGS. 4-5 to describe an alternate embodiment for a deflector of the apparatus 100.

FIG. 4 illustrates one embodiment of a deflector 410 comprising a divider 430 and a plate 420. FIG. 5 illustrates a three-dimensional (3D) view of the apparatus of FIG. 4. As shown in FIG. 5, the divider 430 is, in one approach, located within an interior portion of the nozzle 130. For example, the divider 430 may be located in the center of the nozzle 130, as shown in FIG. 5. In one configuration, the divider 430 is integrated into the interior of the nozzle 130 in a manner that allows the divider 430 to be fixed in place during operation of the apparatus 100. The divider 430 may be integrated into the interior of the nozzle 130 in various configurations. For example, the divider 430 and the nozzle 130 may be machined as a single piece. As another example, the divider 430 may be removably coupled to the interior of the nozzle 130, where the nozzle 130 includes a housing within the interior of the nozzle 130 for receiving the divider 430 as an insert. In one arrangement, the divider 430 spans across the entire interior opening of the nozzle 130, the divider 430 being anchored to opposing sides of the interior of the nozzle 130. On the other hand, in one configuration, the divider 430 is attached to only one side of the interior of the nozzle 130, where the divider 430 does not span the entire opening of the nozzle 130. In any case, the divider 430 is integrated into the interior of the nozzle 130.

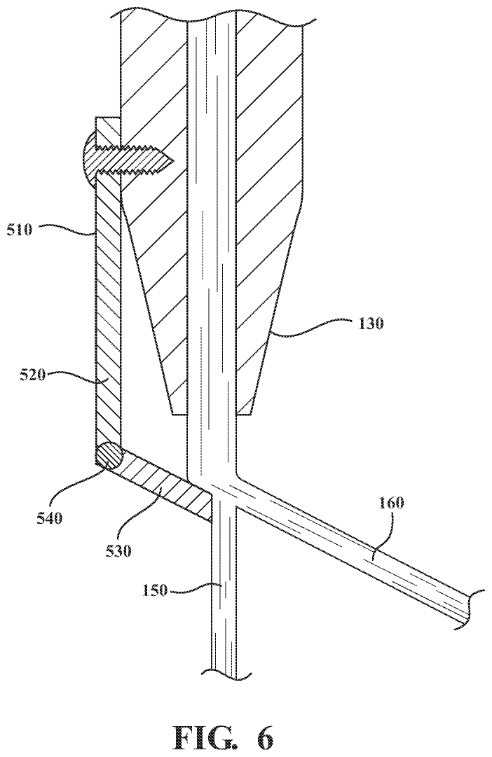

In one approach, the plate 420 is removably coupled to the exterior of the nozzle 130. In one configuration, the divider 430 splits the water jet 120 into the cutting stream of water 150 and the angled stream of water 160 when the divider 430 intersects the water jet 120. For example, as the water jet 120 travels to the opening of the nozzle 130, the water jet 120 contacts the divider 430 before or as the water jet 120 exits the nozzle 130. As such, the divider 430, in one embodiment, splits the water jet 120 into the cutting stream 150 and the angled stream 160 before the water jet 120 exits the nozzle 130. After the cutting stream 150 and the angled stream 160 are formed, the plate 420, in one arrangement, contacts the angled stream 160 to cause the angled stream 160 to contact the substrate at a non-perpendicular angle in relation to the top of the substrate as described previously during the discussion of FIG. 1. The plate 420, in one approach, only extends beneath the portion of the nozzle 130 where the angled stream 160 exits. Accordingly, the plate 420 does not contact the cutting stream 160. The discussion will now shift to FIG. 6 to describe an adjustable deflector that may be used to adjust an angle of the angled stream 160.

FIG. 6 illustrates one embodiment of an adjustable deflector 510. In one configuration, the deflector 510 includes a movable contact 530. In one approach a water jet stream contacts the movable contact 530 as the water jet exits the nozzle 130 to split the water jet into the cutting stream 150 and the angled stream 160. In one approach, the deflector 510 further includes a non-movable anchor 520, where the non-movable anchor 520 is attached to the nozzle 130. The non-movable anchor may be removably coupled to the nozzle 130 or integrated into the nozzle 130. The deflector 510, in one configuration, further includes a hinge 540, where the movable contact 530 and the non-movable anchor 520 are connected by the hinge 540. In one embodiment, the movable contact 530 is rotatable along the hinge 540. Rotating the movable contact 530 changes the position at which the water jet contacts the deflector 510, and as such, moving the movable contact 530 changes an angle of the angled stream. For example, if the movable contact 530 is rotated further away from the nozzle 130, the angled stream will contact the edge at a larger non-perpendicular angle in relation to the top surface of the substrate than if the movable contact is rotated closer to the nozzle 130 (e.g., the angled stream may contact the edge at an 80 degree angle versus a 40 degree angle in relation to the top surface of the substrate). In any case, a user may adjust the angle of the angled stream by moving the movable contact 530.

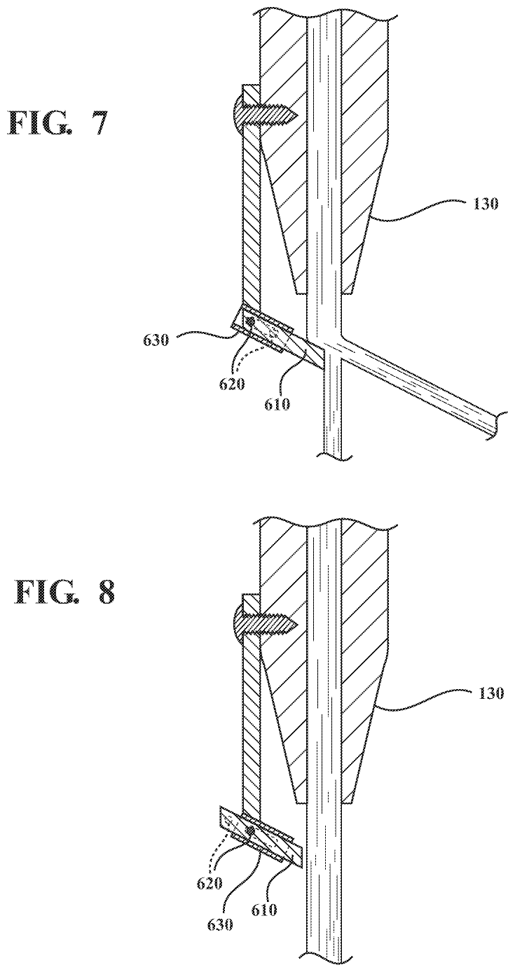

The movement of the movable contact 530 may be manually or automatically controlled. For example, a user may manually move the position of the movable contact 530. In one approach, movable contact 530 includes a motor, where the motor facilitates rotation of the movable contact 530 along the hinge 540. In one embodiment, the motor is coupled to a controller. The controller may be a human machine interface (HMI), such as an interactive display, a button, or a switch. For example, where the controller is a switch, the switch may be movable between three positions including a neutral position, an upward position, and a downward position. In the neutral position, the switch does not cause the movable contact 530 to move. When the switch is moved to the upward position, the motor causes the movable contact 530 to rotate closer to the opening of the nozzle 130. When the switch is moved to the downward position, the motor causes the movable contact 530 to rotate farther away from the opening of the nozzle 130. Accordingly, a user may automate the movement of the movable contact 530 by controlling the position of the switch via programmable logic controller (PLC) programming. In any case when a user interacts with the controller, the controller causes the motor to facilitate movement of the movable contact 530, thereby allowing a user to control the position of the movable contact 530 in relation to the nozzle 130. The discussion will now shift to FIGS. 7 and 8 to describe a deflector that is movable between an active and inactive position.

FIG. 7 illustrates one embodiment of a deflector 610 that splits a water jet stream into a cutting stream and an angled stream of water, where the deflector is in an active position. In one arrangement, the deflector 610 includes a sliding rail 630 attached to an exterior of the nozzle 130, where the deflector 610 is coupled to the sliding rail 630. The deflector 610, in one approach, is movable between an active position and an inactive position along the sliding rail. In one configuration, the deflector 610 further includes one or more pins 620 coupled to the sliding rail 630. The one or more pins 620 lock the deflector 610 in the active position and the inactive position on the sliding rail 630 when the one or more pins 620 are engaged. As shown in FIG. 6, the deflector 610, in one embodiment, include two pins 620. However, it should be understood that any number of pins 620 may be implemented along the sliding rail 630 to lock the deflector 620 in different positions along the sliding rail 630. The deflector 610 is in the active position when the deflector 610 extends beneath a portion of the nozzle 130. As shown in FIG. 6, the shaded pin 620 represents an engaged pin, where the engaged pin prevents the deflector 610 from sliding away from the nozzle 130. The unshaded pin 620 represents a disengaged pin, where the deflector 610 rests on top of the disengaged pin. In this way, the deflector 610 is locked in the active position and will intersect the water jet when the water jet exits the nozzle 130 to form the cutting stream and angled stream.

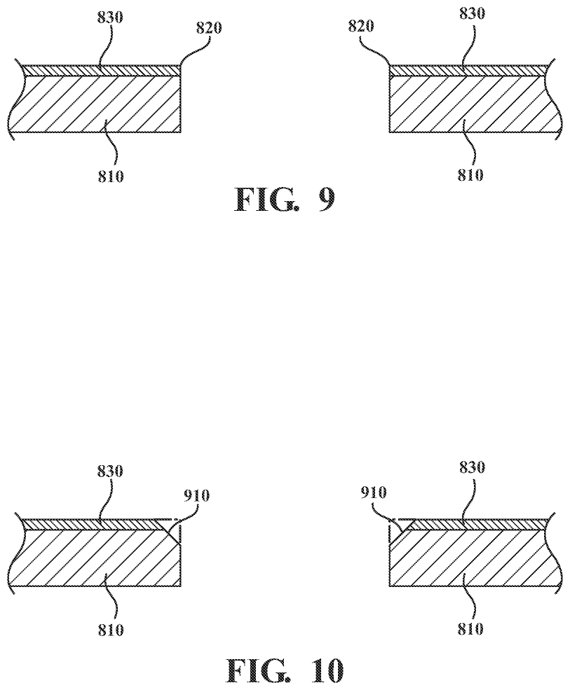

FIG. 8 illustrates one embodiment of the deflector 610, where the deflector 610 is in an inactive position. The deflector 610 is in an inactive position when the deflector 610 does not extend beneath the nozzle 130 to interact with the water jet. As shown in FIG. 7, the shaded pin 620 represents an engaged pin, where the engaged pin prevents the deflector 610 from sliding towards the nozzle 130. The unshaded pin 620 represents a disengaged pin, where the deflector 610 rests on top of the disengaged pin. In this way, the deflector 610 is locked in the inactive position and will not intersect the water jet when the water jet exits the nozzle 130. In any case, the deflector 610 may be moved along the sliding rail 630 to selectively position the deflector 610 in the active and inactive positions, according to the needs of a user, for example. The discussion will now shift to FIGS. 9 and 10 to further describe the process of cutting and conditioning an edge of a substrate using a cutting stream and angled stream of water.

FIG. 9 illustrates one embodiment of a substrate 810 that has been cut in half by a cutting stream of water. As shown, the substrate 810 has a top surface 830 located on both halves of the substrate 810. The top surface 830 is the area of the substrate 810 located outside of and substantially perpendicular to a nozzle, where a water jet exits the nozzle to cut the substrate 810 by contacting the top surface 830. The substrate 810 further includes, in one approach an edge 820 located on an end of the top surface 830. The edge 820 is rigid and sharp as the edge 820 is, in one embodiment, formed from a fiber glass composition.

FIG. 10 will now be discussed in relation to FIG. 9. FIG. 10 illustrates one embodiment of the substrate 810 comprising a conditioned edge 910. As shown, the substrate 810 has a top surface 830 located on both halves of the substrate 810. The top surface 830 is the area of the substrate 810 located outside of and substantially perpendicular to a nozzle, where a water jet exits the nozzle to cut the substrate 810. The conditioned edge 910 is formed when an angled stream of water contacts the edge 820 shown in FIG. 8. The angled stream of water contacts the edge 820 at a pressure sufficient to condition the edge 820 (e.g., dull, smooth, remove a portion of the edge 820, etc.) but at a pressure low enough that the angled stream does not cut through the substrate 810. As shown in FIG. 9, in one embodiment, forming the conditioned edge 910 includes removing a portion of the edge 820. Hoewver, it should be understood that conditioning the edge 820 is not limited to removing a portion of the edge 820, and in one or more arrangements, conditioning the edge 820 includes dulling the edge, smoothing the edge, etc. In this way, the apparatus 100 improves the process of cutting and conditioning the edge of a substrate using a water jet.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An apparatus, comprising:
a nozzle connected on a receiving end with a connecting tube to receive a water jet that is a stream of water accelerated at a high velocity to generate a high pressure for cutting a substrate, and wherein the water jet exits through the nozzle; and
a deflector coupled to the nozzle, wherein the deflector splits the water jet into a cutting stream of water for cutting the substrate and an angled stream of water for conditioning an edge of the substrate.

2. The apparatus of claim 1, wherein the cutting stream of water contacts the substrate at an angle that is substantially perpendicular to a top surface of the substrate to cut the substrate, wherein the top surface of the substrate is an area of the substrate located outside of and substantially perpendicular to an opening of the nozzle.

3. The apparatus of claim 1, wherein the angled stream of water contacts the edge of the substrate at a non-perpendicular angle in relation to a top surface of the substrate to form a conditioned edge, wherein the substrate is substantially planar and includes a core between the top surface and a bottom surface, with the top surface opposing the bottom surface, and wherein the edge is located at an end of the top surface.

4. The apparatus of claim 1, wherein the deflector is integrated into the nozzle to split the water jet into the cutting stream and the angled stream as the water jet exits the nozzle.

5. The apparatus of claim 1, wherein the deflector is removably coupled to an exterior portion of the nozzle.

6. The apparatus of claim 1, wherein the deflector comprises:
a movable contact;
a non-movable anchor, wherein the non-movable anchor is attached to the nozzle; and
a hinge, wherein the movable contact and the non-movable anchor are connected by the hinge.

7. The apparatus of claim 6, wherein the movable contact is rotatable along the hinge, and wherein rotating the movable contact changes an angle of the angled stream.

8. The apparatus of claim 1, further comprising:
a sliding rail attached to an exterior of the nozzle, wherein the deflector is coupled to the sliding rail, and wherein the deflector is movable between an active position and an inactive position along the sliding rail; and
one or more pins coupled to the sliding rail, wherein the one or more pins lock the deflector in the active position and the inactive position on the sliding rail when the one or more pins are engaged.

9. The apparatus of claim 8, wherein the deflector intersects the water jet when the deflector is in the active position to split the water jet into the cutting stream and the angled stream.

10. The apparatus of claim 1, wherein the deflector comprises:
a divider located within an interior portion of the nozzle; and
a plate located outside of the nozzle, wherein the plate is removably coupled to the exterior of the nozzle.

11. The apparatus of claim 10, wherein the divider splits the water jet into the cutting stream of water and the angled stream of water when the divider intersects the water jet, and wherein the plate contacts the angled stream to cause the angled stream to contact the substrate at a non-perpendicular angle.

12. An apparatus, comprising:
a nozzle connected on a receiving end with a connecting tube to receive a water jet that is a stream of water accelerated at a high velocity for cutting a substrate, wherein the water jet exits through the nozzle;
a deflector coupled to the nozzle, wherein the deflector splits the water jet into a cutting stream of water for cutting the substrate and an angled stream of water for conditioning an edge of the substrate,
wherein the cutting stream of water contacts the substrate at an angle that is substantially perpendicular to a top surface of the substrate to cut the substrate, wherein the top surface of the substrate is substantially perpendicular to an opening of the nozzle, and
wherein the angled stream of water contacts the edge of the substrate at a non-perpendicular angle in relation to the top surface of the substrate to form a conditioned edge having an angle that is non-perpendicular in relation to the top surface of the substrate; and
a sliding rail attached to an exterior of the nozzle, wherein the deflector is coupled to the sliding rail, and wherein the sliding rail provides for moving the deflector between an active position and an inactive position.

13. The apparatus of claim 12, wherein the deflector is integrated into the nozzle to split the water jet into the cutting stream and the angled stream as the water jet exits the nozzle.

14. The apparatus of claim 1, wherein the deflector is removably coupled to an exterior portion of the nozzle.

15. The apparatus of claim 14, wherein the deflector comprises:
a movable contact;
a non-movable anchor, wherein the non-movable anchor is attached to the nozzle; and
a hinge, wherein the movable contact and the non-movable anchor are connected by the hinge.

16. The apparatus of claim 15, wherein the movable contact is rotatable along the hinge, and wherein rotating the movable contact changes an angle of the angled stream.

17. The apparatus of claim 12, wherein the deflector intersects the water jet when the deflector is in the active position to split the water jet into the cutting stream and the angled stream.

18. The apparatus of claim 12, wherein the deflector comprises:
a divider located within an interior portion of the nozzle; and
a plate located outside of the nozzle, wherein the plate is removably coupled to the exterior of the nozzle.

19. The apparatus of claim 18, wherein the divider splits the water jet into the cutting stream of water and the angled stream of water when the divider intersects the water jet, and wherein the plate contacts the angled stream to cause the angled stream to contact the substrate at a non-perpendicular angle.

20. An apparatus, comprising:
a nozzle connected on a receiving end with a connecting tube to receive a water jet that is a stream of water accelerated at a high velocity to generate a high pressure for cutting a substrate, and wherein the water jet exits through the nozzle;
a deflector coupled to the nozzle, wherein the deflector splits the water jet into a cutting stream of water for cutting the substrate and an angled stream of water for conditioning an edge of the substrate,
wherein the cutting stream of water contacts the substrate at an angle that is substantially perpendicular to a top surface of the substrate to cut the substrate, wherein the top surface of the substrate is an area of the substrate located outside of and substantially perpendicular to an opening of the nozzle,
wherein the angled stream of water contacts the edge of the substrate at a non-perpendicular angle in relation to the top surface of the substrate to form a conditioned edge having an angle that is non-perpendicular in relation to the top surface of the substrate,
wherein the deflector is removably coupled to an exterior portion of the nozzle, and
wherein the deflector comprises:
a movable contact;
a non-movable anchor, wherein the non-movable anchor is attached to the nozzle; and
a hinge, wherein the movable contact and the non-movable anchor are connected by the hinge, wherein the movable contact is rotatable along the hinge, and wherein rotating the movable contact changes an angle of the angled stream; and
a sliding rail attached to an exterior of the nozzle, wherein the deflector is coupled to the sliding rail, and wherein the sliding rail provides for moving the deflector between an active position and an inactive position.
